(19) United States
(12) Patent Application Publication
(10) Pub. No.: US 2009/0282630 A1
(43) Pub. Date: Nov. 19, 2009

(54) Truck terminal snow screed plow

(76) Inventor: Myron S. Reed, Freehold, NJ (US)

Correspondence Address: CHARLES I. BRODSKY, 2 BUCKS LANE, MARLBORO, NJ, 07746, US

(21) Appl. No.: 12/454,690

(22) Filed: May 22, 2009

Related U.S. Application Data
(63) Continuation-in-part of application No. 11/241,380, filed on Oct. 3, 2005, now abandoned.

(51) Int. Cl. B60S 3/04

(52) U.S. Cl. 15/97.3

(57) ABSTRACT

A snow remover for the roofs of trucks and tractor trailers in which a structure of two vertical supports and a cross piece spanning them in supporting a plow rests upon a connected base plate provided with pairs of pockets on each side of the structure to allow for its lifting by a pair of forklifts operating in tandem and moving to a truck terminal access lane when snow build up removal is warranted, and thereafter moved into storage, in which the snow plow is in the configuration of an elongated-V from side-to-side angled forwardly toward the vehicles to meet substantially one-half way between the two vertical supports.

### CROSS-REFERENCE TO RELATED APPLICATIONS

This application is a Continuation-in-Part of application Ser. No. 11/241,380, filed Oct. 3, 2005.

### STATEMENT REGARDING FEDERALLY SPONSORED RESEARCH OR DEVELOPMENT

Research and development of this invention and application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the removal of snow from vehicle roofs, in general, and to the removal of snow from the roofs of trucks and tractor-trailers, in particular.

2. Description of the Related Art

As will be appreciated, there exist a number of design constructions proposed in the past for dealing with the build-up of snow on vehicle roofs. Typical of these are:

1. U.S. Pat. No. 6,654,978 describes a snow removing device anchored to the ground and includes a manually wound drum for operating winch. The invention is concerned with a substantially resilient skirt which does the scraping of snow, and a manner of controlling the pressure which is exerted on the roof.

2. U.S. Pat. No. 1,492,894 just shows a “duster” for brushing the top of a car.

3. U.S. Pat. No. 1,611,273 shows a scraper suspended at the entrance of a garage into which the vehicle is driven for having the dust collected by an oil treated skirt.

4. U.S. Pat. No. 5,989,356 shows a snow scraping apparatus in the nature of a roller. The height adjustment is accomplished by a hydraulic circuit, with the entire arrangement being secured to the ground.

5. U.S. Pat. No. 6,453,500 discloses a vehicle show removal system which dispenses de-icer fluid from the cross-member for de-icing hard bonded ice, and could also be wash down fluid for washing dirt from the roof. Snow chutes divert the melting snow away. The raising and lowering of the crossbar is accomplished by an automatic sensor, although in other embodiments, it can be manipulated by a user.

6. German Patent DE-197-12-648 describes a truck with a flexible covered roof which could be inflated in a direction to cause collected water and snow to run off.

As another one, U.S. Pat. No. 5,802,654 additionally describes, trucking companies spend considerable money to clear snow from the roofs of trailers after every major snow storm. Such effort not only costs money but requires significant time—so that the operation of the rigs of a large fleet can be delayed significantly after a snow storm. Furthermore, since the snow removal has oftentimes been done manually by workers shoveling from atop the trailers, employers and insurance companies are very concerned about the danger of such workers slipping and falling from the typically 13 foot high trailer roofs.

U.S. Pat. No. 5,802,654 goes on to describe a snow plow arrangement for the roofs of trucks and trailers which functions by having the vehicle move under the snow plow arrangement which is embedded in the ground. The apparatus of the invention is a bridge-like structure with two vertical “I” beams and an upper cross piece which is used to support a vertically adjustable bar. The adjustable bar has a wedge-shaped plow formed on its lower edge, to which is attached a stiff rubber blade; when a snow covered truck or trailer moves under the properly positioned plow, the snow is pushed off the top of the vehicle by the blade and onto the ground. In the preferred embodiment shown, raising the plow is accomplished by a winch on the upper cross piece which reels in a chain from which the plow is hung. To lower the plow, the winch is released and braked, and the chain is pulled out slowly by the weight of the plow.

As will be appreciated by those skilled in the art, there are several inherent problems with this type of snow removal apparatus:

a. First, like the constructions set out in U.S. Pat. Nos. 6,654,978 and 6,453,500, its frame is “stationary”, with the vertical supports being free-standing “I” beams embedded in concrete. For trailers and tractors of typical 70+ foot length, the truck terminal access length then becomes almost permanently tied up all year round with the construction—not the least reason for which is that such operation essentially requires some 150 feet of straightway for the rig to go between the two vertical supports and another 150 feet of straightway for coming out. Sitting there stationary with concrete footings, this type of snow removal apparatus is just in the way after the snow storm has passed, and serves no utilitarian purpose then whatsoever.

b. Secondly, the design of the plow whose blade contacts the snow on the roof is deficient. More specifically, being shaped as a wedge with two angled sections that extend from the center of the plow, two things happen—one, as the truck or trailer proceeds between the “I” beams, the snow essentially gets pushed rearwardly along the roof, building up more and more, and exerting an even greater force and pressure against the “I” beams as the operation continues; and two, the build-up of snow gets higher and higher as this progresses, and flows over the top of the snow plow, back onto that portion of the roof of the truck or trailer which has already passed. In other words, the wedge-shaped configuration does an inadequate job of removal, especially for those areas of the country which experience large and heavy snow falls. Moreover, the pushing of the snow off the back of the roof in this manner necessitates an entire snow plowing of the lane by a following vehicle before another rig can pass through.

c. Thirdly, a separate source of electrical power is required to operate the winch in raising or lowering the plow. As the patent points out, some type of conventional control station is needed for providing the electricity to operate the winch to adjust the plow height.

### SUMMARY OF THE INVENTION

As will become clear from the following description, the apparatus of the present invention comprises a fabricated, portable screed steel structure which can be easily moved with two fork lifts to place the structure in position when needed, and to remove it to a storage area when not in use—thereby freeing up the access lane at the truck terminal. As welded or bolted in being formed, the screed structure can be set up in less than one hour by two fork lifts operating in tandem to bring the structure into position, and by the placing of concrete blocks on top of its base plate as ballast to fix it. The adjustable plow which pushes off the snow accumulation, furthermore, is of an elongated-V configuration from side-to-side facing forwardly, so that as the truck or trailer proceeds through, the build-up is pushed off its sides, instead of primarily towards its back.

The raising and lowering of the elongated-V type plow is accomplished, additionally, by a boat winch operated from a 12 volt heavy duty truck battery. A control box and cable connector allows the winch operator to stand upwards of 30 feet and more away in viewing the snow clearing from the roof at many different angles to observe the adequacy of the plow operation. In such manner, the operator can determine whether the height of the plow should be adjusted upwardly or downwardly, and whether the wiper blade at the bottom of the plow is making sufficient contact with the roof, or whether the blade is bending too much from the force being applied. By being able to stand this distance away, the one operator needed for the snow removal is also able to be in position to communicate with the driver of the truck in directing what speed to travel at and when to start and stop. With the elongated-V shaped plow pushing the snow sideways from off the roof, less effort is required of a following vehicle to plow the lane free for the next rig to pass through in having its roof cleared of the snow build-up before entering onto a street or highway, and complying with Department of Transportation regulations as to roof snow removal.

### BRIEF DESCRIPTION OF THE DRAWINGS

These and other features of the present invention will be more clearly understood from a consideration of the following description, taken in connection with the accompanying drawings in which:

FIG. 1 is a pictorial view of the truck terminal snow screed of the invention as it would appear ready for the removal of snow from the roofs of trucks and tractor trailers;

FIG. 2 is a front view of the snow screed, a rear view being a mirror image;

FIG. 3 is a left side view of the snow screed frame, a right side view likewise being a mirror image; and

FIG. 4 is a top view of the truck terminal snow screed of the invention.

### DETAILED DESCRIPTION OF THE INVENTION

As with the snow remover of U.S. Pat. No. 5,802,654, the truck terminal snow screed 10 of the invention includes two vertical supports 12, 14 separated by a distance sufficient to move truck and tractor trailer vehicles between the supports. Also as in the construction of U.S. Pat. No. 5,802,654 the snow screed 10 includes a snow plow 16 attached to the vertical supports 12, 14 located at a height which permits the vehicles to be moved under the plow while snow on the roofs of the vehicles is pushed off the vehicles. Additionally, as with that patent, the snow plow 16 is attached to the vertical supports by moving means which permit the plow 16 to be adjusted vertically along the supports 12, 14. As will become clear from the following description, however, the differences which exist between the snow remover of the present invention as compared to that of U.S. Pat. No. 5,802,653 allow for less effort in the snow build-up removal, and a freeing of an additional truck terminal lane for vehicle access for substantially all occasions when a moderate to heavy snow has not fallen.

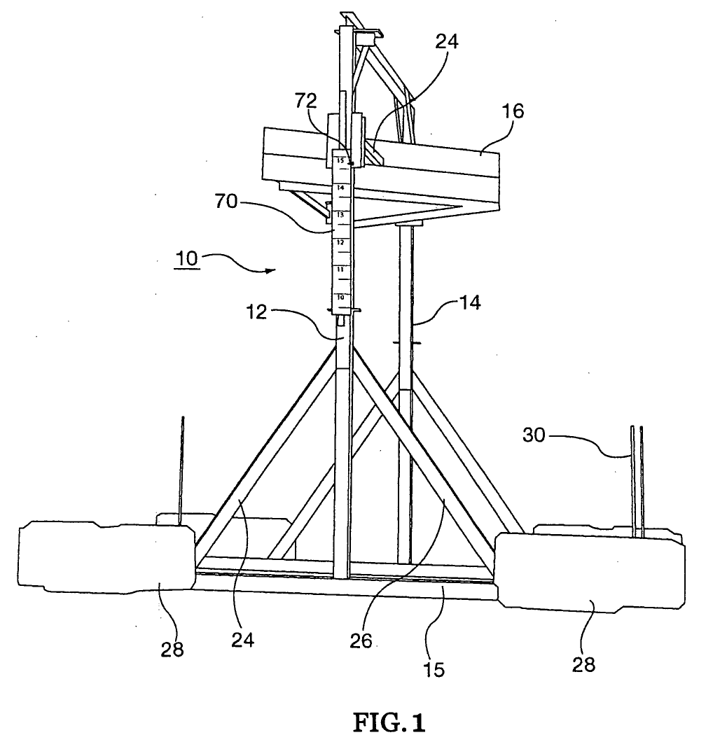

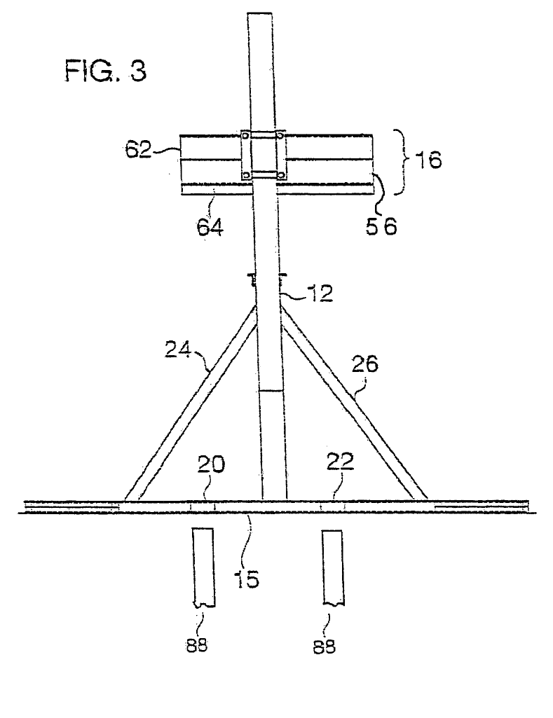

More specifically, and in accordance with one aspect of the invention, the truck terminal snow screed structure 10 comprises a fabricated steel frame of I-beams having first and second pockets 20, 22 on base plates 15 to be raised by two fork lifts operating in tandem in moving the frame into position for the trucks and tractor trailers to then pass through. As will be appreciated and understood, safety chains may be incorporated among the frame and forklift to prevent the frame from sliding off while it is being moved, along with a further “stiff pole” (not shown) bolted between the two side sections so they do not separate if one forklift should pull more than the other—and with the pole then being removed once the frame is properly placed in the lane so as not to block passage of the vehicles which then go through. As will be understood, one set of forks 88 goes in the pockets 20, 22 on each side—and moving into position, one forklift backs up, and one goes forward. With the forks of these lifts being commonly 4 feet apart, the pockets 20, 22 may be located some 2 feet on either side of the vertical supports 12, 14, one pocket forward and one pocket backward. As FIGS. 1 and 3 illustrate, for support and strengthening besides the vertical supports 12 and 14 being welded or bolted to the base plate 15, their lower portions are also welded or bolted in a “delta” configuration with the base plate 15, as by knee braces 24, 26.

To fix the frame and hold it steady once in position, one or more concrete blocks 28 are employed as ballast. To such end, the base plate I-beams 15 are of a length which extends beyond the “delta” configuration of the vertical supports for receiving the concrete blocks moved by the forklifts by the handle grips 30 (with the blocks 28 weighing approximately 3 tons each). The screed frame structure 10 in one construction of the invention weighed some 8,800 pounds, and two forklifts with capacities of 5,000 pounds each operating in tandem were able to move the screed 10 into position and set it up, or remove it. This, of course, is not possible with the snow remover of U.S. Pat. No. 5,802,654 where its vertical supports are permanently embedded into the ground. As will also be understood, this allows the snow remover of the present invention to be portable about the truck terminal, opening up the access lanes when no roof clearing is required.

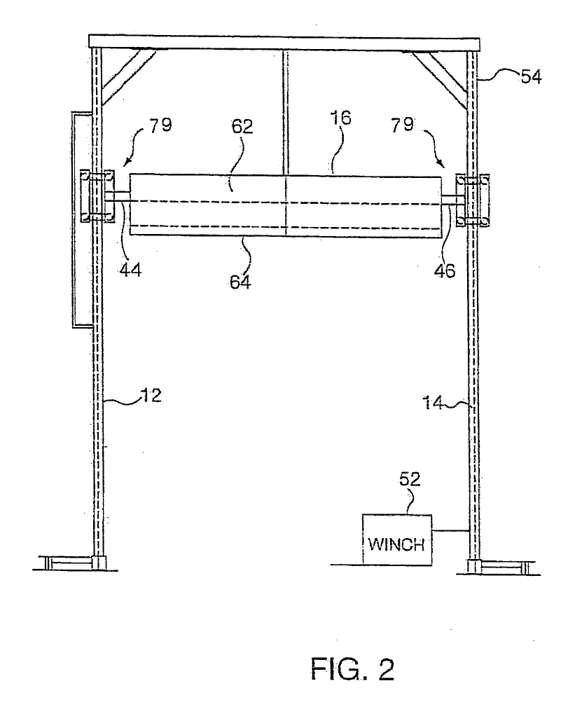

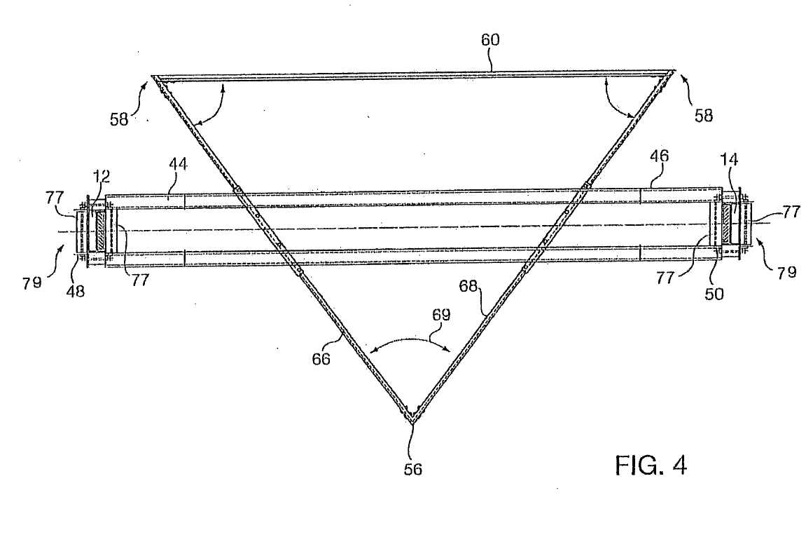

Additionally, and in accordance with the invention, an elongated-V configuration snow plow 16 is employed, angled from side-to-side instead of merely a wedge as in the plow of the U.S. Pat. No. 5,802,654. As shown in FIGS. 1, 2 and 4, the plow 16 couples to be raised and lowered by first and second crossbars 44, 46 which extend from a pair of brackets 48, 50 on individual ones of the vertical supports 12, 14. As FIGS. 1 and 4 more specifically show, the elongated-V type plow 16 is angled forwardly toward the vehicles to meet substantially one-half way between the supports 12, 14. A boat winch 52 and chain assembly 54 utilizing a pair of cables over a pulley (not shown) serve to raise and lower the plow 16 in counter-weighted fashion. As FIG. 4 illustrates, the crossbars 44, 46 extend to the opposing side surface of the elongated-V angled snow plow 16 at a point substantially one-half way back from the nose end 56 of the plow 16. At the tail ends 58 of the elongated-V angled plow 16, a third crossbar 60 extends. A roller and shaft assembly 79 wraps around each side of the vertical supports 12 and 14 to reduce any tendency for the plow 16 to bind up when being raised and lowered, the individual rollers being shown at 77 around each of the 4 sides of the supports 12 and 14. Such rollers serve to keep the plow 16 from bending on the supports in any direction, as frequently and undesirably occurred with the U.S. Pat. No. 5,802,654 patented construction.

With an upper portion 62 of the snow plow 16 being constructed of a structural steel material, a lower portion 64 may be composed of a neoprene rubber material to serve as a wiper blade, and to protect the roof of the truck or tractor trailer passing beneath. With the upper and lower portions bolted or otherwise secured together, the elongated-V angled snow plow 16, in a preferred embodiment, extends forwardly of the vertical supports 12, 14, a distance of substantially 4′6″. The elongated-V angled snow plow 16 extends rearwardly of the supports 12, 14, in this embodiment, a distance of substantially 3′6″. The angle formed by the opposing side surfaces 66, 68 of the elongated-V angled snow plow 16 is shown at 69 (of some 74°)—and with the opposing side surfaces 66, 68 being of a length of substantially 10 feet each, moving the truck or tractor trailer beneath the plow effectively forces the snow build-up sideways, i.e. off both its sides, instead of rearwardly along the roof of the vehicle as with the construction of the U.S. Pat. No. 5,802,654 patented design. This follows, especially, by having the snow plow extend continuously rearwardly from its nose end 56 past the vertical supports 12 and 14 to its tail ends 58 that distance and at that angle of the V-configuration so that the separation at the tail ends 58 is substantially equal to or greater than the width of the truck or trailer roof to be cleared of snow. Less force is thus presented on the wiper blade 64 as it is moved from front-to-back of the roof—thereby extending the plow's useful life—and there is much less of a tendency for any heavy snow build-up to traverse over the top of the plow as the snow-clearing process continues. As will be appreciated by those skilled in the art, this, more readily, allows the operation to comply with and satisfy Department of Transportation regulations concerning the removal of snow from trucks and tractor trailers entering the roads and highways. And, as will be understood, can eliminate the need to plow out the access lane of accumulated snow before a following truck or trailer can pass through to have its own roof cleared, as described below.

In accordance with the invention, the elongated-V angled snow plow 16 is constructed of a height chosen between 15 and 30 inches along its length, with the upper blade 64 being some 8 inches in height bolted to the upper portion 62 to extend some 4 inches below. A one inch width has been found sufficient for the wiper blade 64 to adequately clear snow build-up, and by bolting the blade 64 to the upper portion 62, further allows for its being reversed in orientation as the lower portion extent of it contacting the roof wears, so that it may be inverted in direction. As will be understood by those skilled in the art, “V-angling” the snow off the sides of the vehicle roofs not only lessens the force exerted on the plow as the vehicle moves forwardly, but equally serves in keeping the access lane freer of snow for a following truck or tractor trailer. For “low-to-moderate” snow areas, a 15 inch height for the plow may suffice—while for “moderate-to-high” snow areas, a greater height may be required so that the snow does not back over the top of the plow as the vehicle proceeds forward.

The truck terminal snow screed of the invention further distinguishes from that of U.S. Pat. No. 5,802,654 by the employment of the slow-moving boat winch 52 with a 12 volt heavy duty truck battery for raising and lowering the elongated-V type plow 16. Rather than having to tie into a conventional control station for providing the electricity to operate the winch of that patent's teaching, utilizing a boat winch and a truck battery in this manner allows its operator to adjust the height of the plow by a simple control box and cable connection. This enables an operator to stand upwards of 30 feet and more away in viewing the snow clearing operation from different positions in monitoring the plow operation, and also enables an operator to stand nearer the driver of the truck or trailer in advising him/her when to start, when to stop, and at what speed to travel at.

To further facilitate observing the operation of the wiper blade 64 and monitoring its effectiveness, a height gauge 70 is mounted on one of the vertical supports (12 in FIG. 1), marked off in 6 inch intervals to correspond with the different heights of the vehicle roofs from off the ground, as displayed on the vehicle's body. A needle pointer 72 is fixed with the bracket 48, and set so that the bottom edge of the wiper blade 64 is in alignment with the vehicle roof. By having the cable connection to the truck battery, the winch operator is able to stand far enough away to determine whether the wiper blade 64 is making sufficient contact, or whether it is bending too much from the force being applied because of improper height setting. FIG. 1 illustrates the raising of the plow to a height such that the bottom edge of the wiper blade 64 is at 13′6″, the roof height of approximately 90% of the trailers on the road today.

In accordance with the invention, then, a fabricated, portable steel structure is provided for screeding the roofs of trucks and tractor trailers of snow build-up. The screed structure can be easily moved with a pair of forklifts for placement in a storage area when not needed for use, and can be set up in less than one hour in the truck terminal access or exit lane. Once set up, only a single operator is required for controlling the operation, and only one piece of conventional snow removal equipment is needed to remove the build-up pushed off the sides from the roof before the next truck or tractor trailer is presented. As the vehicle passes underneath, the plow with the neoprene rubber wiper is adjusted to the proper height, controllable by the operator as needed to best effectuate the snow build-up removal. No field welding, use of concrete footings, or any special preparation is necessary before everything can be put in place for use.

While there have been described what are considered to be to be preferred embodiments of the present invention, it will be readily appreciated by those skilled in the art that modifications can be made without departing from the scope of the teachings herein of a snow remover structure which is portable, and movable from place-to-place. As the description makes clear, this frees up the space in a truck terminal where the roofs of truck and trailer vehicles are to be scraped of snow and ice accumulations before being taken out of the road. As the Specification sets out, the portable snow remover structure is liftable by the use of a pair of forklifts in being transported between the two locations. Once in position, first and second pairs of ballast weights are set in place on each of the base plates defined, on opposing side of each of the two vertical supports. With the ballast weights preferably being in the form of one or more concrete blocks (as called out), the weights secures the snow remover structure in position. The pairs of ballast weights are defined as being removable from the base plates when it is desired to move the snow remover structure to a new location. To facilitate this, the apparatus of the invention calls out the dimensioning of the base plate pockets to receive the forks of a pair forklift trucks so as to move the portable snow remover of the invention from the first to the second location. In such manner, this invention distinguishes from the prior art previously noted whose structures include the limitations of “fixedness” which then promptly ties up a traffic lane in the terminal—even during the summer where there is no need for snow or ice removal.

Using the wedge-shaped configuration of the plow in pushing the snow accumulations sideways from off the roof, furthermore, reduces the need for a snow plowing of the lane by a following vehicle before another rig can pass through—as typified the prior art. Using a wedge-shaped configuration where the elongated-V plow extends at an angle a distance rearwardly of the point where the cross piece carrying the plow attaches to the vertical supports to spread the plow a distance substantially equal to or greater than the width of the vehicle's roof will be seen to obviate the need entirely as all the snow would then be pushed off sideways.

As this description makes clear, all this allows less effort to be expended in having a truck or trailer roof cleared of snow build up before the vehicle enters on a street or highway in an easily controllable manner without damaging the roof of the vehicle; and in assuring an optimum removal through being able to direct the actions of the driver of the truck or trailer in proceeding between the vertical supports of the snow remover structure—both without binding on the vertical supports because of the roller-shaft assembly wrapping. Moreover, the arrangement allows the snow removal operator to adjust the height of the plow while standing away from the plow to view its clearing operation. Such connection enables the snow removal operator to stand nearer the driver of the truck or trailer in advising the driver when to start proceeding under the plow, and at what speed to travel at in so doing. With the included height gauge and needle pointer, proper plow-settings can be arranged to clear the snow from truck or trailer roofs, and with specifications set for the plow itself, this virtually eliminates not only the snow from a truck's roof falling on the street or highway, but clears the snow in a manner that does not require further plowing of the truck terminal lane where the removal of snow roof material took place.

For at least such reasons, therefore, resort should be had to the claims appended hereto for a true understanding of the scope of the invention.

I claim:

1. A snow remover for truck and trailer vehicles comprising:
two vertical supports separated by a distance sufficient to allow the driving of truck and trailer vehicles between the two vertical supports;
a cross piece attached at a point between the vertical supports at respective upper portions of the two vertical supports for spanning the distance separating the two vertical supports;
a snow plow attached to the cross piece and located at a height which permits the truck and trailer vehicles to be driven forwardly under the snow plow while pushing snow on a roof of a driven vehicle substantially completely off the vehicle, sideways; and
means coupled to the cross piece and to the vertical supports for moving the cross piece and attached snow plow upwardly and downwardly along the vertical supports;
wherein the snow plow is in the configuration of an angled elongated-V from side-to-side with a nose end pointed forwardly toward the vehicle being driven so as to meet substantially one-half way between the two vertical supports;
wherein the moving means includes a first bracket positionally adjustable on one of the two vertical supports, a second bracket positionally adjustable on the other of the two vertical supports, a first cross bar extending from said first bracket to a first side surface of the snow plow, and a second cross bar extending from said second bracket to an opposing side surface of the snow plow;
wherein the first and second cross bars extend to the opposing side surfaces of the elongated-V angled snow plow at a point substantially one-half way back from a nose end of the elongated-V angled snow plow;
a roller assembly wrapped around each of the two vertical supports;
a boat winch and chain assembly included within the moving means to raise and lower the snow plow;
with the elongated-V configuration of the snow plow extending continuously from said nose end rearwardly past said point of attachment of said cross piece with said vertical supports and at the angle of said V-configuration to separate opposing tail ends of said plow a distance substantially equal to or greater than the width of a roof of a truck or trailer being driven between the two vertical supports to be cleared of snow; and
with at least a lower portion of the snow plow being of a material which will not damage a roof of a driven vehicle if brought into contact therewith.

2. The snow remover of claim 1, also including a third cross bar extending between the opposing side surfaces of the angled elongated-V snow plow substantially at said tail ends thereof.

3. The snow remover of claim 2, including a heavy duty truck battery for operating said boat winch.

4. The snow remover of claim 3, including a cable connector and control box between said truck battery and said boat winch for controllably raising and lowering said snow plow.

5. The snow remover of claim 4 wherein an upper portion of the snow plow is constructed of a structural steel material.

6. The snow remover of claim 5 wherein the angled elongated-V snow plow is constructed of an upper portion of structural steel bolted to a lower portion of neoprene rubber.

7. The snow remover of claim 4 wherein the angled elongated-V snow plow extends forwardly of the vertical supports a distance of substantially 4′6″.

8. The snow remover of claim 7 wherein the angled elongated-V snow plow extends rearwardly of the vertical supports a distance of substantially 3′6″.

9. The snow remover of claim 8 wherein the opposing side surfaces of the angled elongated-V snow plow are each of a length of substantially 10 feet.

10. The snow remover of claim 9 wherein the angle formed by the opposing side surfaces of the angled elongated-V snow plow at the nose end thereof is substantially 74°.

11. The snow remover of claim 6 wherein the upper portion of the angled elongated-V snow plow is of a height of between 15-30 inches along the length thereof.

12. The snow remover of claim 6 wherein the angled elongated-V angled snow plow is constructed of an upper portion of structural steel secured to a lower portion of neoprene rubber of substantially 8 inches in height and ¾ inches in width bolted to the upper portion to extend substantially 4 inches therebelow.

13. The snow remover of claim 3, also including a height gauge on at least one of the vertical supports.

14. The snow remover of claim 13, including a needle pointer fixed with at least one of said brackets to align a bottom edge of the angled elongated-V snow plow with a roof of the vehicle moved into position between the two vertical supports.

15. A snow remover for truck and trailer vehicles comprising:
two vertical supports separated by a distance sufficient to allow the driving of truck and trailer vehicles between the two vertical supports;
a cross piece attached at a point between the vertical supports at respective upper portions of the two vertical supports for spanning the distance separating the two vertical supports;
a snow plow attached to the cross piece and located at a height which permits the truck and trailer vehicles to be driven forwardly under the snow plow while pushing snow on a roof of a driven vehicle substantially completely off the vehicle, sideways; and
means coupled to the cross piece and to the vertical supports for moving the cross piece and attached snow plow upwardly and downwardly along the vertical supports;
wherein the snow plow is in the configuration of an angled elongated-V from side-to-side with a nose end pointed forwardly toward the vehicle being driven so as to meet substantially one-half way between the two vertical supports;
wherein the moving means includes a first bracket positionally adjustable on one of the two vertical supports, a second bracket positionally adjustable on the other of the two vertical supports, a first cross bar extending from said first bracket to a first side surface of the snow plow, and a second cross bar extending from said second bracket to an opposing side surface of the snow plow;
wherein the first and second cross bars extend to the opposing side surfaces of the elongated-V angled snow plow at a point substantially one-half way back from a nose end of the elongated-V angled snow plow;
a roller assembly wrapped around each of the two vertical supports;
a boat winch and chain assembly included within the moving means to raise and lower the snow plow;
with the elongated-V configuration of the snow plow extending continuously from said nose end thereof rearwardly past said point of attachment of said cross piece with said vertical supports at the angle of said V-configuration to separate opposing tail ends of said plow a distance substantially equal to or greater than the width of a roof of a truck or trailer being driven between the two vertical supports to be cleared of snow;
with at least a lower portion of the snow plow being of a material which will not damage a roof of a driven vehicle if brought into contact therewith;
also including a third cross bar extending between the opposing side surfaces of the angled elongated-V snow plow substantially at said tail ends thereof;
including a heavy duty truck battery for operating said boat winch;
including a cable connector and control box between said truck battery and said boat winch for controllably raising and lower said snow plow;
wherein an upper portion of the snow plow is constructed of a structural steel material;
wherein the angled elongated-V snow plow is constructed of an upper portion of structural steel bolted to a lower portion of neoprene rubber;
wherein the angled elongated-V snow plow extends forwardly of the vertical supports a distance of substantially 4′6″;
wherein the angled elongated-V snow plow extends rearwardly of the vertical supports a distance of substantially 3′6″;
wherein the opposing side surfaces of the angled elongated-V snow plow are each of a length of substantially 10 feet;
wherein the angle formed by the opposing side surfaces of the angled elongated-V snow plow at the nose end thereof is substantially 74°;
wherein the upper portion of the angled elongated-V snow plow is of a height of between 15-30 inches along the length thereof; and
wherein the angled elongated-V snow plow is constructed of an upper portion of structural steel secured to a lower portion of neoprene rubber of substantially 8 inches in height and ¾ inches in width bolted to the upper portion to extend substantially 4 inches therebelow.

16. The snow remover of claim 15, also including a height gauge on at least one of the vertical supports.

17. The snow remover of claim 16, including a needle pointer fixed with at least one of said brackets to align a bottom edge of the angled elongated-V snow plow with a roof of the vehicle moved into position between the two vertical supports.
